(19) United States
(12) Patent Application Publication
(10) Pub. No.: US 2013/0009777 A1
(43) Pub. Date: Jan. 10, 2013

(54) DEVICE AND METHOD FOR THE PREVENTION OF WANDERING

(75) Inventors: Ronaldus Maria Aarts, Eindhoven (NL); Jeroen Wals, Eindhoven (NL)

(73) Assignee: KONINKLIJKE PHILIPS ELECTRONICS N.V., EINDHOVEN (NL)

(21) Appl. No.: 13/636,345

(22) PCT Filed: Mar. 17, 2011
(86) PCT No.: PCT/IB2011/051116

§ 371 Date: Sep. 21, 2012

(30) Foreign Application Priority Data
Mar. 25, 2010 (EP) 10157774.0

(51) Int. Cl. G08B 3/10

(52) U.S. Cl. 340/573.4

(57) ABSTRACT

There is provided a device for use by a user who may wander that comprises an audio unit for generating a first output audible to the user in response to a determination that the user is within a predetermined safe area. The audible output preferably comprises music. There is also provided a method of operating a device that is to be worn or carried by a user, comprising generating a first output audible to the user using an audio unit in the device in response to a determination that the user is within a predetermined safe area.

### TECHNICAL FIELD OF THE INVENTION

The invention relates to a device and a method for helping to prevent a user from wandering out of a safe area.

### BACKGROUND OF THE INVENTION

In relation to other age groups, senior citizens (i.e. aged 60 and over) are the fastest-growing segment of the US population. Many are healthy, vivacious individuals, but it is estimated that 16 million elderly people in the US have Alzheimer's disease, a condition marked by memory loss, confusion and trouble communicating. Common to Alzheimer's disease, dementia and other debilitating illnesses, is the propensity for the subject to wander. Wandering can help relieve anxiety and restlessness in the subject and may serve as exercise when the subject can wander in a safe, contained or controlled area. However, too often confused subjects wander away from home or care giving centers, or may leave their beds at night. In these cases, it is very easy for the subject to become lost or injured.

According to the Alzheimer's Association, around half of those who wander and are not found within 24 hours may suffer serious injury or even death. This statistic has led individuals to try to find ways to safeguard elderly loved ones who tend to wander.

U.S. Pat. No. 6,570,503 to Izaak A. Ulert and Henry Lang describes an emergency signaling device that comprises an alarm that is activated if the device is transported beyond a pre-set distance from a base station. The device can sound an audible alarm and/or voice message requesting assistance and identifying the caretakers of the subject upon activation.

However, it has been found that such devices are not particularly effective for subjects that are suffering from Alzheimer's disease, dementia or similar conditions, as these subjects may have trouble receiving and understanding warnings and/or alarms.

Therefore, there is a need for an improved device and method that can be used by a subject to help prevent them from wandering out of a safe area.

### SUMMARY OF THE INVENTION

As described above, it has been found that subjects with Alzheimer's disease, dementia or similar conditions may have difficulty receiving and understanding warnings and/or alarms.

Therefore, a first aspect of the invention provides a device for use by a user who may wander that comprises an audio unit for generating a first output audible to the user in response to a determination that the user is within a predetermined safe area.

Thus, the user of the device will be presented with an audible output while they remain within the predetermined safe area (which should be the majority of the time), which may be their home, care home, hospital, their street, etc, and the user will become conditioned that the first audible output is associated with their being within a safe area.

Preferably, the first output audible to the user comprises music. This provides significant advantages as it has been found that subjects with Alzheimer's disease, dementia or similar conditions can understand, process and respond to certain types of sounds, such as music, better than other types of sound, such as speech or alarm signals, so it makes it easier for the subject to understand that they are within a safe area. Furthermore, the music provided to the user can be used as part of music therapy, which has been shown to be beneficial to subjects with Alzheimer's disease, dementia or similar conditions.

The first audible output may comprise a specific track or tracks of music, music selected from a specific genre or just music in general. Preferably the music (whether it is a single track, a number of tracks or a particular genre or genres) is familiar to the user from before they became ill (such as music from their childhood).

In a further embodiment of the invention, the audio unit is configured to generate a second output audible to the user that is different to the first output in response to a determination that the user is outside the predetermined safe area. As the user will have become conditioned to or learned that the first audible output is associated with the safe area, presenting the user with a second audible output that is different to the first audible output will alert the user that they are no longer within the safe area.

Preferably, the second audible output comprises music, speech, synthetic signals or warning signals. If the first audible output and second audible output comprises music, the music output when the user is outside the safe area will be substantially different from the music output when the user is within the safe area so that the user is alerted that they have left the safe area. For example, the music output when the user is outside the safe area may have a different tempo or may be a different style of music.

Preferably, the audio unit is configured to switch between generating the first audio output to generating the second audio output as the user moves from within the predetermined safe area to being outside the predetermined safe area, and vice versa. In this way, the user can be alerted when they leave or re-enter the safe area and this allows the user to learn where the boundary of their designated safe area is.

In an embodiment, the device further comprises a control unit for the audio unit, the control unit being configured to generate a control signal for the audio unit based on whether the user is within the predetermined safe area. Thus, in this embodiment, the device contains the processing means required to control the audio unit, which means that the device does not need to receive the audio unit control signal from a remote station or base unit.

In yet another embodiment, the control unit for the audio unit is further configured to receive user location information relating to the location of the user, to determine whether the user is within the predetermined safe area using the user location information and to generate the control signal for the audio unit accordingly. In this embodiment, the device contains the processing means required to control the audio unit and to determine whether the user is within the predetermined safe area, which means that the device also does not need to receive the result of the determination from a remote station or base unit.

In a preferred embodiment, if the control unit determines that the user is outside the predetermined safe area, the control unit is configured to further determine whether the user is in an area predetermined to be potentially harmful to the user from the user location information and, if the user is determined to be in such an area, to generate an alarm signal for transmission to a remote monitoring station. In this way, the device can summon assistance from a care provider, relative or neighbor if the user leaves the safe area (if the entire area outside the safe area is considered to be potentially harmful to the user) or if they enter a particular area outside the safe area that is considered to be potentially harmful, in addition to providing the user with the first audible output when they are within the safe area.

In a further or alternative embodiment, if the control unit determines that the user is outside the predetermined safe area, the control unit is configured to further determine whether the user is in an area predetermined to be potentially harmful to the user from the user location information and, if the user is determined to be in such an area, to generate a control signal for the audio unit that causes the audio unit to generate a third output audible to the user that is different to the first output and the second output. In this way, the user can be presented with a different audible output to that presented while they are within the safe area or while they are outside the safe area but not at immediate risk of harm.

In a preferred embodiment, the device comprises a sensor for providing user location information relating to the location of the user. Thus, in this embodiment, the device is fully self-contained and does not require any external components in order to operate.

In a further embodiment, the audio unit is further configured to generate an output audible to the user in response to a determination regarding the user's gait or movements. The user's gait or particular movements can provide an indication as to whether the user's wandering (whether within the safe area or not) could result in the user coming to harm, and the device can use this to provide the user with an audible output that can alert them to their current risk of harm.

In yet another embodiment, the device further comprises a first power source for supplying power to the audio unit; and a second power source for supplying power to at least one further component of the device; wherein the first power source is configured to also supply power to the at least one further component in the event that the second power source is unable to supply power to the at least one further component. Thus, in this embodiment, the invention can be implemented into an existing device that comprises one or more components having a respective power source, and the power source provided for powering the invention can be used as a back-up power source for those components, and/or it can be used to charge the power source for those components.

In an alternative embodiment, the device further comprises a power source for supplying power to at least one further component of the device; wherein the power source is configured to supply power to the audio unit only in the event that the power source has sufficient stored power to supply power to the at least one further component and the audio unit. In this way, the invention can be implemented into an existing device that comprises one or more components having their own power source, and the audio unit will only be activated when there is sufficient power available for the entire device. Otherwise, the audio unit and functionality according to the invention will be disabled, preventing any adverse impact on the performance of the other components in the device.

According to a second aspect of the invention, there is provided a method of operating a device that is to be worn or carried by a user, the method comprising generating a first output audible to the user using an audio unit in the device in response to a determination that the user is within a predetermined safe area.

Preferably, the first output audible to the user comprises music.

In a preferred embodiment, the step of generating further comprises generating a second output audible to the user using the audio unit that is different to the first output in response to a determination that the user is outside the predetermined safe area. Preferably, the second output comprises music, speech, synthetic signals or warning signals.

In a preferred embodiment, the step of generating comprises switching between generating the first audio output using the audio unit to generating the second audio output using the audio unit as the user moves from within the predetermined safe area to being outside the predetermined safe area, and vice versa.

In a further embodiment, the method further comprises the step of generating a control signal for the audio unit based on whether the user is within the predetermined safe area. In some embodiments, an indication of whether the user is within the predetermined safe area can be provided to the device, but in alternative embodiments, the step of generating a control signal for the audio unit comprises determining whether the user is within the predetermined safe area using received user location information and generating the control signal for the audio unit accordingly.

In one embodiment, if it is determined that the user is outside the predetermined safe area, the method further comprises the step of determining whether the user is in an area predetermined to be potentially harmful to the user from the user location information and, if the user is determined to be in such an area, generating an alarm signal for transmission to a remote monitoring station.

In a further or alternative embodiment, if it is determined that the user is outside the predetermined safe area, the method further comprises the step of determining whether the user is in an area predetermined to be potentially harmful to the user from the user location information and, if the user is determined to be in such an area, generating a control signal for the audio unit that causes the audio unit to generate a third output audible to the user that is different to the first output and the second output.

In a further embodiment, the method further comprises obtaining user location information relating to the location of the user.

In yet another embodiment, the method further comprises the step of generating an output audible to the user in response to a determination regarding the user's gait or movements.

In another embodiment, the method further comprises the steps of supplying power to the audio unit from a first power source, supplying power to at least one further component from a second power source, and supplying power from the first power source to the at least one further component in the event that the second power source is unable to supply power to the at least one further component.

In an alternative embodiment, the method further comprises the steps of supplying power to at least one further component from a power source and supplying power to the audio unit from the power source only in the event that the power source has sufficient stored power to supply power to the at least one further component and the audio unit.

According to a third aspect of the invention, there is provided a computer program product comprising computer readable code that is configured to cause a computer or processor to generate a control signal for an audio unit in a device in response to a determination that a user of the device is within a predetermined safe area, the control signal causing the audio unit to generate a first output audible to the user. According to embodiments of the invention, the computer readable code may be executed by a control unit or processor within the device, or may be executed by a computer or processor external to the device.

### BRIEF DESCRIPTION OF THE DRAWINGS

Specific embodiments of the invention will now be described, by way of example only, with reference to the following drawings, in which:

FIG. 1 is a block diagram illustrating an exemplary device according to an embodiment of the invention;

FIG. 2 is an illustration of the device of FIG. 1 being worn by a user;

FIG. 3 is a flow chart illustrating an exemplary method according to an embodiment of the invention;

FIG. 4 is a block diagram illustrating an exemplary device according to another embodiment of the invention; and

FIG. 5 is a block diagram illustrating an exemplary device according to yet another embodiment of the invention.

### DETAILED DESCRIPTION OF THE PREFERRED EMBODIMENTS

FIG. 1 shows a device 2 for the prevention of wandering in accordance with an embodiment of the invention. The device 2 comprises an audio unit that is configured to generate an output audible to a user of the device 2 in response to a control signal from a control unit 6. The audio unit 4 may comprise any conventional means for providing the audible output, for example a loudspeaker, a set of head- or ear-phones, a socket for a set of head- or ear-phones and/or an induction coil for interfacing with a user's hearing aid. The audible output may comprise, for example, music, recorded verbal messages, synthesized speech or an alarm signal.

In this embodiment, the control unit 6 is connected to a location sensor 8 that provides information relating to the location of the user. The location sensor 8 can comprise any suitable sensor for providing the position or location of the user, for example a GPS receiver, an RFID tag reader (for where the user's environment has RFID tag's positioned at particular locations), a magnetometer and/or an accelerometer.

A memory 10 is connected to the control unit 6 and can store information for use by the audio unit 4 in producing the audible output, for example audio samples or one or more data files representing music or other sounds. The memory 10 also stores information relating to an area or areas that are regarded as safe for the user to be in. This information can define the area itself, or a boundary of the safe area with an unsafe area. Alternatively, or in addition, the memory 8 can store information relating to an area or areas that are considered as unsafe to the user and/or considered to be areas where the user is at particular risk of harm or injury. The nature of the information stored in the memory 10 will depend on the particular user location information provided by the location sensor 8. For example, if the location sensor 8 is a GPS receiver, the memory 10 can store information relating to the safe area in terms of latitudes and longitudes.

The area or areas that are considered safe/unsafe for the user can be determined by a relative of the user, a care provider, etc. and the relevant information for identifying these areas can be uploaded to the device 2 and stored in the memory 10.

It will be appreciated that the area or areas considered to be safe or unsafe do not have to be fixed and they may vary depending on the time of day. For example, during the day, the safe area for a user in a care home may comprise a number of different rooms, but at night the safe area may only comprise the user's bedroom.

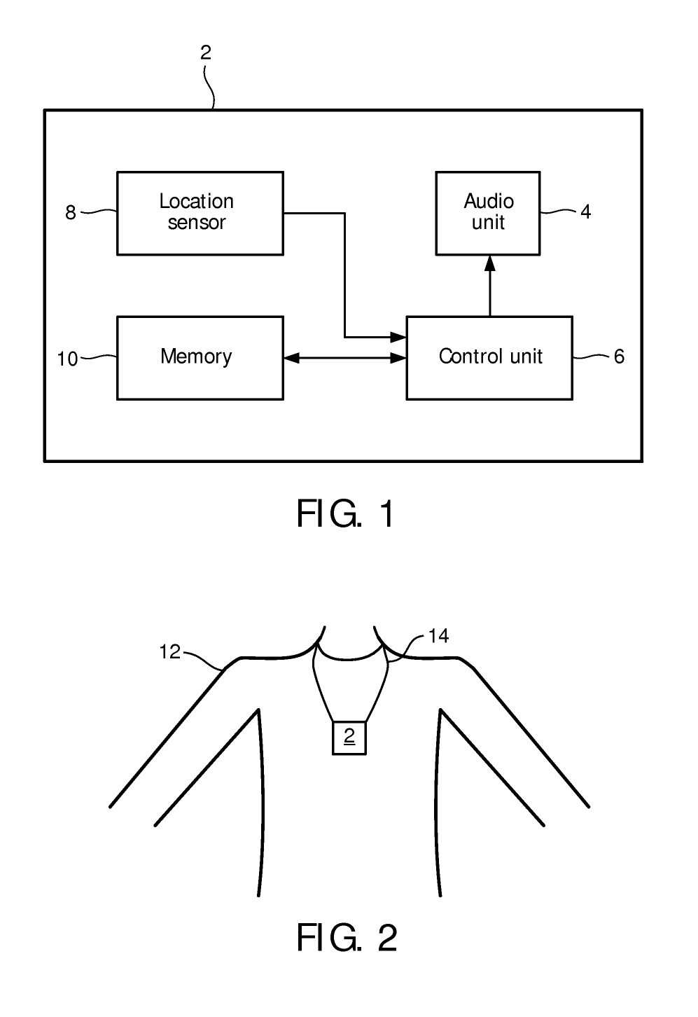

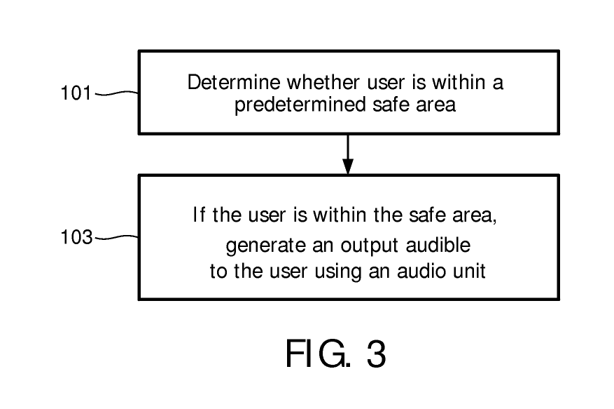

FIG. 2 shows a preferred embodiment of the device 2 being worn as a pendant around the neck of a user 12. The device 2 is held in place around the neck of the user 12 by a thread or chain 14. Alternatively, the device 2 can be provided in the form of a watch or wrist band for use on the arm of the user 12, or it can be worn or placed on any other suitable part of the body of the user 12.

The operation of the device 2 illustrated in FIG. 1 will now be described with reference to FIG. 3. In step 101, the device 2 determines whether the user 12 is within a predetermined safe area. That is, the control unit 6 retrieves the relevant safe/unsafe area information from the memory 10 and compares it to the user location information received from the location sensor 8 to determine whether the user is within the predetermined safe area.

If the control unit 6 determines that the user 12 is within the predetermined safe area, the control unit 6 generates a control signal that causes the audio unit 4 to generate an output that is audible to the user 12 (step 103).

Preferably, the audible output is music, and even more preferably, the music is familiar to the user 12 (for example from their childhood or from before they were unwell). In this way, the user 12 will become conditioned that the safe area is associated with music or that particular track or type of music and the music will facilitate music therapy, either passively or through active engagement with the user 12, which has been shown to be beneficial for people with Alzheimer's disease, dementia or other similar conditions.

If the control unit 6 determines from the user location information that the user 12 is outside of the safe area or has left the safe area, the control unit 6 provides a control signal to the audio unit 4 that causes the audio unit 4 to provide a different audible output to the user 12. This audible output may also comprise music (although a different track or type of music) and/or other sounds, such as a recorded verbal warning message, a synthesized warning message or alarm signal. In this way, the user 12 will be able to recognize that the area is not safe and will return to a safe area where they hear the first audible output.

If the memory 10 has information stored therein regarding areas where the user is particularly at risk of injury or harm and the user 12 is determined to be in one of these areas, the control unit 6 may cause the audio unit 4 to provide yet another output audible to the user 12 to warn the user 12 that they could be at risk of harm. Alternatively or in addition, the control unit 6 may send or transmit a signal to a remote monitoring station to warn a relative or care provider that the user 12 is wandering and is at risk of harm (although it will be appreciated that the means required for sending or transmitting this signal are not shown in FIG. 1).

It will be appreciated that, in alternative embodiments, the control unit 6 may send or transmit a signal to a remote monitoring station as soon as it is determined that the user 12 has wandered outside the safe area.

As the user's body movements and/or gait can provide a useful indication of the condition of the user 12 while they are wandering (whether within a safe area or not), the control unit 6 can, in a further embodiment of the invention, process the user location information (if appropriate) or information from other sensors in the device 2 to classify the user's movements or gait. The control unit 6 can use the result of this processing to send or transmit a signal to a remote monitoring station and/or to modify the audible output generated by the audio unit 4.

In a particular embodiment of the invention referred to above, the location sensor 8 can make use of RFID technology. For example, in one implementation, the location sensor 8 in the device 2 is an RFID tag, and there are one or more RFID tag readers distributed around the environment in which the user 12 resides. The RFID tag, as known, contains a silicon chip and an energizing coil, and has a user identification number stored therein. The coil is inactive until it moved into a magnetic field generated by a RFID tag reader that is located, for example, in a mat near the door of the room of the user 12, at the door of care home, at the gate at the garden belonging to the care home etc. The RFID tag then transmits its user identification number to a receive antenna in the RFID tag reader. In this embodiment, the location information obtained by the RFID tag reader (i.e. including the location of the RFID tag reader) is then provided to the control unit 6 so that a determination can be made whether the user 12 is within a safe area.

In an alternative implementation, the location sensor 8 in the device 2 is an RFID tag reader, and there are one or more RFID tags distributed around the environment in which the user 12 resides. The RFID tag reader reads the identification number of nearby RFID tags and the control unit 6 determines the location of the user from this information.

In a further embodiment of the invention, the device 2 can be used in conjunction with is not necessarily fully integrated in the device as shown in FIG. 1, but part of the system might be in external boxes. E.g. to facilitate tapping along, or humming along with the music, additional interface might be used, e.g. a keyboard or microphone.

It will be appreciated by those skilled in the art that the device 2 shown in FIG. 1 is merely an exemplary embodiment of the invention, and it may not be necessary for a device that implements the invention to include all of the components or functionality shown. For example, some or all of the functionality implemented by the control unit 6, location sensor 8 and/or memory 10 may be provided in another device that is remote from the device 2, such as a computer, PDA or base unit. In these embodiments, any information that needs to be passed between the device 2 and the remote device can be transmitted wirelessly or through a wired connection.

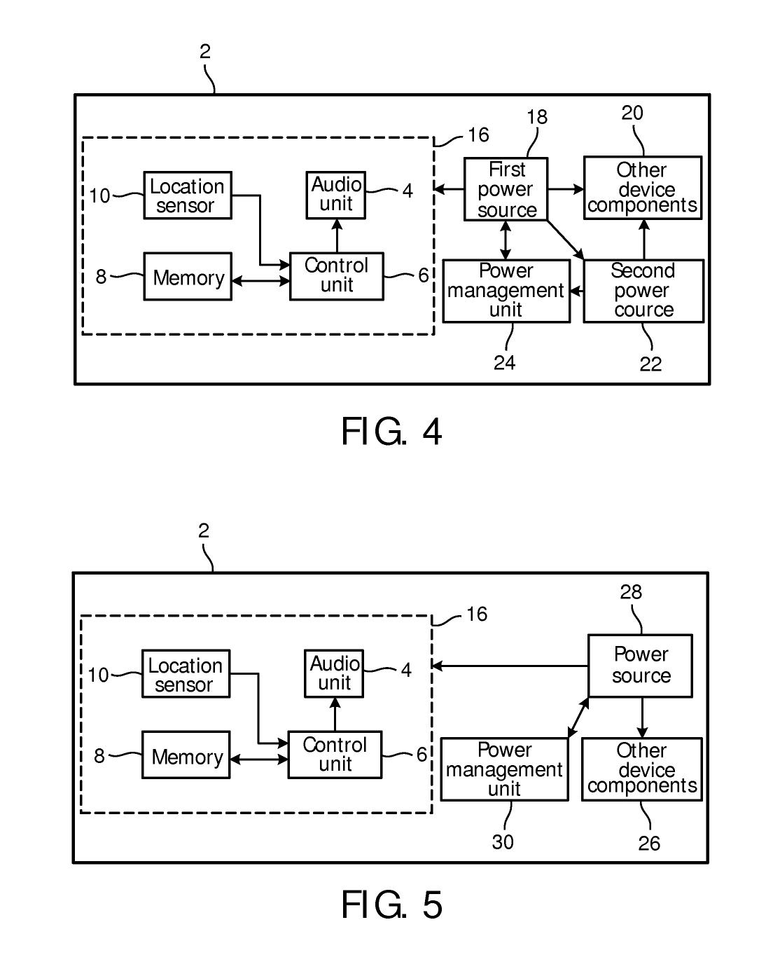

Further embodiments of the invention are shown in FIGS. 4 and 5. In these embodiments, the invention is incorporated into a device 2 that includes additional functionality to that provided by the invention. For example, the invention can be incorporated into a device 2 that serves as a Personal Help button (PHB), such as the Philips Lifeline Classic Pendant Personal Help Button (http://www.lifelinesys.com/content/lifeline-products/classic-pendant.jsp).

In this situation, it is important to make sure that the operation of the invention does not impede the normal operation of the device 2 (for example being able to summon help in an emergency).

Therefore, in the device 2 of FIG. 4, a first power source 18 is provided that supplies power to the components that implement the invention, shown in dashed box 16. The device 2 also includes other components 20, such as circuitry for implementing the Personal Help Button functionality (for example a transmitter for sending an alert signal to a remote monitoring station and a button for the user to press if they require help), with a respective (second) power source 22.

In this embodiment, the first power source 18 is also connected to the other components 20 of the device 2 so that it can act as a backup or reserve power source for the components 20 if the second power source 22 is no longer able to provide power to the components 20 (i.e. if the second power source 22 has been fully drained).

The device 2 further includes a power management unit 24 that is connected to the first and second power sources 18, 22. The power management unit 24 monitors the condition of the first and second power sources 18, 22 and enables the supply of power from the first power source 18 to the components 20 in the event that the power supplied by the second power source 22 falls below a threshold value.

Alternatively, the first power source 18 can be configured to charge the second power source 22 in the event that the power management unit 24 determines that the power supplied by the second power source 22 has fallen below a threshold value.

In an alternative embodiment, as shown in FIG. 5, the components 16 that implement the invention and the other device components 26 are connected to a shared power source 28. However, in order to preserve and prioritize the functionality of the other components 26 in the device 2, power is only supplied to the components 16 if the power source 28 has sufficient remaining power to power the whole device 2. Otherwise, a power management unit 30 controls the power source 28 so that power is only supplied to the other device components 26.

As described above, the device 2 according to specific embodiments of the invention can help to facilitate music therapy for the user 12. To further help the user 12 with music therapy, the device 2 can be enabled for use with one or more external user interfaces, such as a keyboard or a microphone, so that the user 12 can tap, hum or sing along with the music.

Therefore, there is provided a device and method that can be used to help prevent a user of the device from wandering out of a safe area.

While the invention has been illustrated and described in detail in the drawings and foregoing description, such illustration and description are to be considered illustrative or exemplary and not restrictive; the invention is not limited to the disclosed embodiments.

Variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied alone, together with or as part of other hardware, but may also be distributed in other forms, such as via the Internet or other wired or wireless telecommunication systems. Any reference signs in the claims should not be construed as limiting the scope.

1. A device (2) for use by a user (12) who may wander, the device (2) comprising:
an audio unit (4) for generating a first output audible to the user (12) in response to a determination that the user (12) is within a predetermined safe area.

2. A device (2) as claimed in claim 1, wherein the first output audible to the user (12) comprises music.

3. A device (2) as claimed in claim 1, wherein the audio unit (4) is configured to generate a second output audible to the user (12) that is different to the first output in response to a determination that the user (12) is outside the predetermined safe area.

4. A device (2) as claimed in claim 3, wherein the second output comprises music, speech, synthetic signals or warning signals.

5. A device (2) as claimed in claim 3, wherein the audio unit (4) is configured to switch between generating the first audio output to generating the second audio output as the user (12) moves from within the predetermined safe area to being outside the predetermined safe area, and vice versa.

6. A device (2) as claimed in claim 1, wherein the device (2) further comprises:
a control unit (6) for the audio unit (4), the control unit (6) being configured to generate a control signal for the audio unit (4) based on whether the user (12) is within the predetermined safe area.

7. A device (2) as claimed in claim 6, wherein the control unit (6) for the audio unit (4) is further configured to receive user location information relating to the location of the user (12), to determine whether the user (12) is within the predetermined safe area using the user location information and to generate the control signal for the audio unit (4) accordingly.

8. A device (2) as claimed in claim 7, wherein if the control unit (6) determines that the user (12) is outside the predetermined safe area, the control unit (6) is configured to further determine whether the user (12) is in an area predetermined to be potentially harmful to the user (12) from the user location information and, if the user (12) is determined to be in such an area, to generate an alarm signal for transmission to a remote monitoring station.

9. A device (2) as claimed in claim 7, when dependent on claim 3 or 4, wherein if the control unit (6) determines that the user (12) is outside the predetermined safe area, the control unit (6) is configured to further determine whether the user (12) is in an area predetermined to be potentially harmful to the user (12) from the user location information and, if the user is determined to be in such an area, to generate a control signal for the audio unit (4) that causes the audio unit (4) to generate a third output audible to the user (12) that is different to the first output and the second output.

10. A device (2) as claimed in claim 7, the device (2) further comprising:
a sensor (8) for providing user location information relating to the location of the user (12).

11. A device (2) as claimed in claim 1, wherein the audio unit (4) is further configured to generate an output audible to the user (12) in response to a determination regarding the user's gait or movements.

12. A device (2) as claimed in claim 1, the device (2) further comprising:
a first power source (18) for supplying power to the audio unit (4); and
a second power source (22) for supplying power to at least one further component (20) of the device (2);
wherein the first power source (18) is configured to also supply power to the at least one further component (20) in the event that the second power source (22) is unable to supply power to the at least one further component (20).

13. A device (2) as claimed in claim 1, the device (2) further comprising:
a power source (28) for supplying power to at least one further component (26) of the device (2); wherein the power source (28) is configured to supply power to the audio unit (4) only in the event that the power source (28) has sufficient stored power to supply power to the at least one further component (26) and the audio unit (4).

14. A method of operating a device that is to be worn or carried by a user (12), the method comprising:
generating a first output audible to the user using an audio unit in the device in response to a determination that the user is within a predetermined safe area (103).

15. A method as claimed in claim 14 further comprising generating using the audio unit a second output audible to the user (12) that is different to the first output in response to a determination that the user (12) is outside the predetermined safe area (103).

16. A method as claimed in claim 15 further comprising switching between generating the first output audible to the user and the second output audible to the user when the user (12) is moving from being within the predetermined safe area to being outside the predetermined safe area (103), and vice versa.

17. A method as claimed in claim 16, wherein a determining whether the user (12) is moving from being within the predetermined safe area (103) to being outside the predetermined safe area and vice versa includes receiving user location information relating to the location of the user (12).

18. A method as claimed in claim 17 further comprising determining from the user location information whether the user (12) is in an area predetermined to be potentially harmful to the user (12) and, if the user (12) is determined to be in such an area, generating an alarm signal for transmission to a remote monitoring station.

19. A method as claimed in claim 14 wherein the first output audible to the user (12) comprises music familiar to the user.

20. A computer program product comprising computer readable code that is configured to cause a computer or processor to:
generate a control signal for an audio unit in a device in response to a determination that a user of the device is within a predetermined safe area, the control signal causing the audio unit to generate a first output audible to the user.
